(19) United States
(12) Patent Application Publication
(10) Pub. No.: US 2009/0188945 A1
(43) Pub. Date: Jul. 30, 2009

(54) SILICON GEL DISPENSING DEVICE

(75) Inventor: Kuan-Chun WU, Jhonghe City (TW)

Correspondence Address: PATENTTM.US, P. O. BOX 82788, PORTLAND, OR, 97282-0788, US

(73) Assignee: CICERO TECHNOLOGY CO., LIMITED, Jhonghe City (TW)

(21) Appl. No.: 12/021,225

(22) Filed: Jan. 28, 2008

(51) Int. Cl. B67D 5/58; B65D 88/54; G01F 11/00

(52) U.S. Cl. 222/190; 222/333; 222/386

(57) ABSTRACT

A silicon gel dispensing device has a barrel connected with a compressor and having a discharging tube, a container mounted inside the barrel and connected securely to the discharging tube and a driver mounted beside the barrel and having an extendable axle attached to a piston of the container. The axle selectively pushes the piston to keep the piston closely abutting the silicon gel inside the container. So that high-pressured air inside the barrel for pressuring the piston is hardly permeating through a slight gap formed between the container and piston. Thus bubbles mixed with the silicon gel are avoided and silicon gel residue and uneven application surface occurring due to bubbles are effectively prevented too.

### BACKGROUND OF THE INVENTION

1. Field of the Invention

The present invention relates to a dispenser, and more particularly to a silicon gel dispensing device that avoids silicon gel residue and uneven application surface occurring due to bubbles.

2. Description of Related Art

With reference to FIG. 4, a silicon gel dispenser comprises a barrel (50), a cover (60) and a container (70).

The barrel (50) is hollow and has an inner space, a front end and a rear end. The front end is sealed and has a discharging tube (51) mounted therethrough, the rear end is defined with an opening.

The cover (60) is mounted to the barrel (50) to cover the opening and has an inlet (61) formed thereon. The inlet (61) connects to an air compressor and allows air with high pressure to flow into the barrel (50).

The container (70) is disposed in the inner space of the barrel (50), is tubular and contains silicon gel and has a front end and a rear end. The front end of the container (70) has a mouth (71) mounted securely with the discharging tube (51). The rear end of the container (70) has a piston (72) mounted slidably therein.

When using the silicon gel dispenser, high-pressured air generated by the compressor is flowing into the inner space of the barrel (50) via the inlet (61) of the cover (60) and gradually pressurizes and moves the piston (72) of the container (70) to make silicon gel discharge from the discharging tube (51).

Since the piston (72) is slidably mounted in the container (70), there is a slight gap formed between the rear end of the container (70) and piston (72), thus high-pressured air may inevitably permeate into the container (70) and forms a couple of bubbles mixed with the silicon gel. Such leads to occurring of the silicon gel residue inside the container (70) and uneven application surface due to bubbles explosion.

To overcome the shortcomings, the present invention provides a silicon gel dispensing device for a portable electronic device to obviate or mitigate the aforementioned problems.

### SUMMARY OF THE INVENTION

The main objective of the present invention is to provide a silicon gel dispensing device that avoids silicon gel residue and uneven application surface occurring due to bubbles.

To achieve the objective, the silicon gel dispensing device in accordance with present invention comprises a barrel, a cover, a container and a driver.

The barrel is hollow and has an inner space, a front end and a rear end. The front end is sealed and has a discharging tube mounted therethrough, the rear end is defined with an opening.

The cover is mounted to the barrel to cover the opening and has an inlet formed thereon. The inlet is for connecting to an air compressor and allowing high-pressured air generated by the compressor flow into the barrel.

The container is disposed in the inner space of the barrel, is tubular and contains silicon gel and has a front end and a rear end. The front end of the container has a mouth mounted securely with the discharging tube. The rear end of the container has a piston mounted slidably therein. Such that high-pressured air generated by the compressor is flowing into the inner space of the barrel via the inlet of the cover and gradually pressurizes and moves the piston of the container to make silicon gel discharge from the discharging tube.

The driver may be a cylinder, has an axle extending through the cover in an airtight manner to attach to the piston of the container and is selectively stretched out from the driver to push the piston to keep the piston closely abutting the silicon gel inside the container. So that high-pressured air is hardly permeating through a slight gap formed between the rear end of the container and piston to form bubbles mixed with the silicon gel and the silicon gel dispensing device in accordance with present invention effectively avoids silicon gel residue and uneven application surface occurring due to bubbles.

Other objectives, advantages and novel features of the invention will become more apparent from the following detailed description when taken in conjunction with the accompanying drawings.

### BRIEF DESCRIPTION OF THE DRAWINGS

FIG. 1 is a side view in partial section of a silicon gel dispensing device in accordance with the present invention;

FIG. 2 is an end view in partial section of the silicon gel dispensing device in FIG. 1;

FIG. 3 is an operational side view in partial section of the silicon gel dispensing device in FIG. 1; and

FIG. 4 is a side view in partial section of a conventional silicon gel dispenser in accordance with prior art.

### DETAILED DESCRIPTION OF THE PREFERRED EMBODIMENT

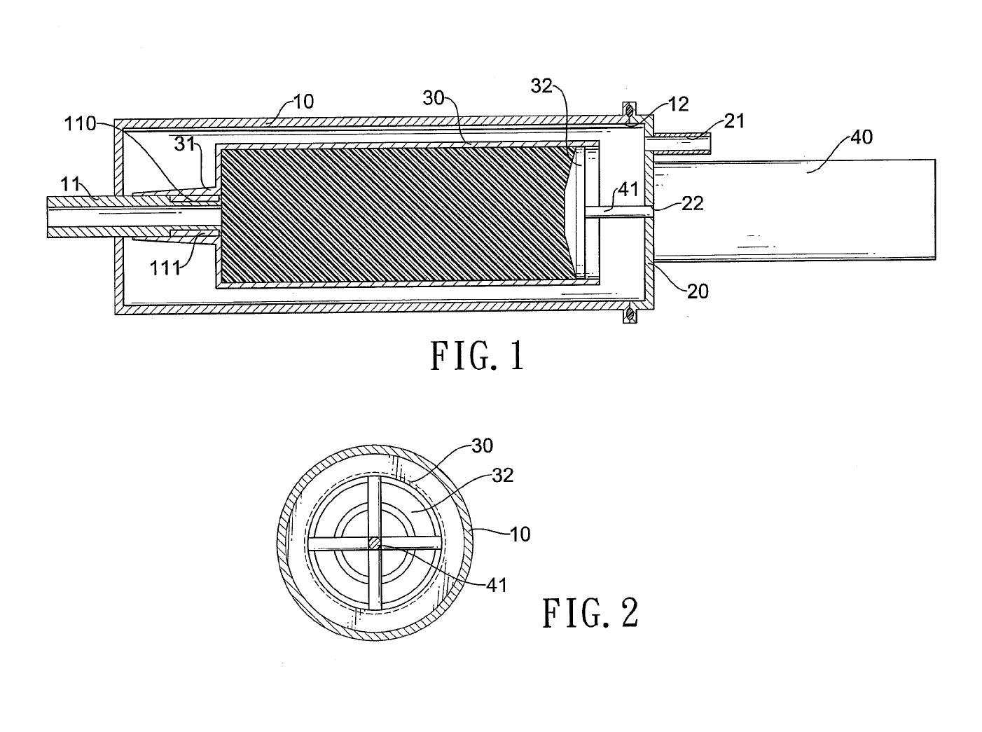

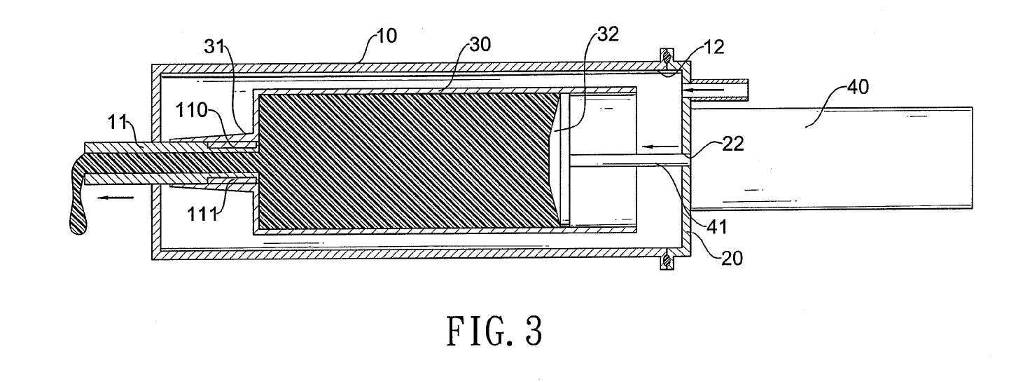

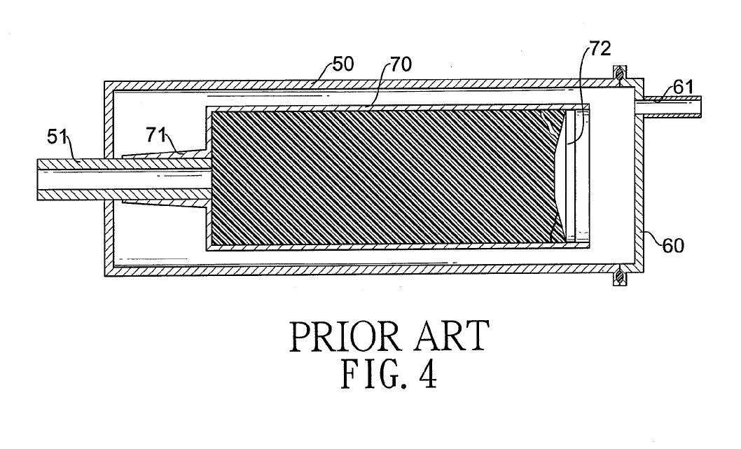

With reference to FIGS. 1, 2 and 3, the silicon gel dispensing device in accordance with present invention comprises a barrel (10), a cover (20), a container (30) and a driver (40).

The barrel (10) is hollow and has an inner space, a front end and a rear end. The front end is sealed and has a discharging tube (11) mounted therethrough, and the discharging tube (11) has an inner end, an annular groove (110) formed diametrically around the inner end and at least one resilient sealing ring (111) mounted in the annular groove (110). The rear end of the barrel (10) is defined with an opening (12).

The cover (20) is mounted to the barrel (10) to cover the opening (12) and has an inlet (21) and an axle hole (22) formed separately through the cover. The inlet (21) connects to an air compressor and allows high-pressured air generated by the compressor to flow into the barrel (10). The axle hole (22) is formed through a center of the cover (20).

The container (30) is disposed in the inner space of the barrel (10), is tubular and contains silicon gel and has a front end and a rear end. The front end of the container (30) forms a mouth (31). The mouth (31) is formed around and hold the discharging tube (11) and has an inner surface abutting the sealing ring (111) of the discharging tube (11), so as to tightly mount securely with the discharging tube (11). The rear end of the container (30) has a hole and a piston (32) mounted in the hole. The piston (32) is fit for an inner surface of the container (30) and is capable of sliding along the inner surface to pressure the silicon gel inside the container (30).

The driver (40) may be a cylinder, has an axle (41) extending through the axle hole (22) of the cover (20) in an airtight manner. The axle (41) has a distal end attached securely to the piston (32) of the container (30), preferably to a center of the piston (32), and is selectively stretch out from the driver (40) to push the piston (32).

When using the silicon gel dispensing device, high-pressured air generated by the compressor is flowing into the inner space of the barrel (10) via the inlet (21) of the cover (20) and gradually pressurize and moves the piston (32) of the container (30) to apply force to the silicon gel inside the container (30) for discharging from the discharging tube (11).

Meanwhile, the driver (40) drives the axle (41) to stretch out from the driver (40) to push and keep the piston (32) closely abutting the silicon gel inside the container (30). So that high-pressured air is hardly permeating through a slight gap formed between the rear end of the container (30) and piston (32) to form bubbles mixed with the silicon gel.

Thus, the silicon gel dispensing device in accordance with present invention effectively avoids silicon gel residue and uneven application surface occurring due to bubbles.

Even though numerous characteristics and advantages of the present invention have been set forth in the foregoing description together with details of the structure and function of the invention, the disclosure is illustrative only. Changes may be made in detail especially in matters of shape, size and arrangement of parts within the principles of the invention to the full extent indicated by the broad general meaning of the terms in which the appended claims are expressed.

What is claimed is:

1. A silicon gel dispensing device comprising
a barrel being hollow and having
an inner space;
a front end being sealed and having a discharging tube mounted through the front end; and
a rear end being defined with an opening;
a cover being mounted to the barrel to cover the opening and having an inlet formed through the cover and adapted for connecting to an air compressor to allow pressured air generated by the compressor to flow into the barrel; and
a container being disposed in the inner space of the barrel, being tubular for containing silicon gel and having
a front end forming a mouth formed around and holding the discharging tube to tightly mount securely with the discharging tube; and
a rear end having
a hole; and
a piston being mounted slidably in the hole and being fit for an inner surface of the container; and
a driver having an axle extending through the cover in an airtight manner and having a distal end attached securely to the piston of the container and being selectively stretched out from the driver to push the piston.

2. The silicon gel dispensing device as claimed in claim 1, wherein
the discharging tube further has
an inner end;
an annular groove formed diametrically around the inner end; and
at least one resilient sealing ring mounted in the annular groove; and
the mouth of the front end of the container has an inner surface abutting the at least one sealing ring of the discharging tube so as to tightly mount securely with the discharging tube.

3. The silicon gel dispensing device as claimed in claim 1, wherein
the cover further has an axle hole formed through the cover; and
the axle of the driver is extending through the axle hole of the cover in an airtight manner.

4. The silicon gel dispensing device as claimed in claim 3, wherein the axle hole is formed through a center of the cover.

5. The silicon gel dispensing device as claimed in claim 4, wherein the driver is a cylinder.
